(19) United States
(12) Patent Application Publication
(10) Pub. No.: US 2024/0262486 A1
(43) Pub. Date: Aug. 8, 2024

(54) ACCESS DOOR ASSEMBLY FOR AN AIRCRAFT

(71) Applicant: Airbus Operations SAS, TOULOUSE (FR)

(72) Inventors: Patrick LIEVEN, TOULOUSE (FR); Anthony MERTES, TOULOUSE (FR); Flavio Ferreira RAIMUNDO, BLAGNAC (FR)

(21) Appl. No.: 18/428,366

(22) Filed: Jan. 31, 2024

(30) Foreign Application Priority Data
Feb. 2, 2023 (FR) 2300990

(51) Int. Cl. B64C 1/14

(52) U.S. Cl. CPC B64C 1/1461

(57) ABSTRACT

An access door assembly for a fuselage having a structure delimiting an access hatch, an upper part and a lower part of an access door, hinges fastened between the structure and the upper part in the vicinity of an upper edge, a guiding system between the lower part and the structure and guiding the lower part in translation, upper locks between the upper part and the lower part and/or the structure and lower locks between the lower part and the structure.

### CROSS-REFERENCES TO RELATED APPLICATIONS

This application claims the benefit of French Patent Application Number 2300990 filed on Feb. 2, 2023, the entire disclosure of which is incorporated herein by way of reference.

### FIELD OF THE INVENTION

The present invention relates to an access door assembly for an aircraft, and to an aircraft equipped with such an assembly.

### BACKGROUND OF THE INVENTION

For maintenance of an aircraft, an operator has to be able to easily access the technical elements that are housed behind the panels constituting the fuselage of the aircraft.

In order to make this access easier, access hatches are disposed along the fuselage and they are closed by access doors fastened by removable fastening means to the structure of the aircraft.

FIG. 1 shows a cross section along a vertical plane of an aircraft 100 of the prior art. The aircraft 100 has a fuselage 102 that has a chassis 101 and aerodynamic panels fastened on the chassis 101. The fuselage 102 encloses two tanks 104, in particular dihydrogen tanks.

In order to perform maintenance on the tanks 104, the fuselage 102 has an access hatch 106 that is created through the chassis 101 and that is closed off by an access door 108 mounted so as to be able to move on the chassis 101. The access hatch 106 extends generally on either side of a horizontal plane XY passing through the center of the fuselage 102 and over a certain height so as to allow an operator access to the inside of the fuselage 102.

This access hatch 106 and the associated access door 108 are disposed at a certain height with respect to the ground 50, and this requires the use of a boarding staircase 52.

This access hatch 106 and the associated access door 108 are disposed on the side of the tank 104.

There are currently various types of access doors 108 that do not make it possible to easily access the inside of the fuselage 102.

There are access doors 108 that open inwards (arrow 54), but with such an access door 108 there is a risk of collision with the tank 104 and the space for maneuvering the access door 108 is small.

There are access doors 108 that open outwards (arrow 56) by rotation about a hinge axis disposed horizontally in the top part of the access door 108, but with such an access door 108 there is a risk of collision with the boarding staircase 52.

### SUMMARY OF THE INVENTION

An object of the present invention is to propose an access door assembly for an aircraft that does not have the drawbacks of the prior art and that makes it possible to allow access to an access hatch without risk of collision with the surroundings.

To this end, an access door assembly for a fuselage of an aircraft having a chassis is proposed, said assembly having:
a structure delimiting an access hatch and intended to be as one with said chassis,
an access door having an upper part and a lower part,
hinges fastened between the structure and the upper part in the vicinity of an upper edge of the upper part and having a horizontal hinge axis,
a guiding system arranged between the lower part and the structure and guiding the lower part in translation with respect to the structure, parallel to a direction of translation intended to be oriented towards the top and the outside of the fuselage during opening of the access door,
upper locking means that are mounted on the upper part and that are able to move between a locking position in which they lock the upper part with the lower part and/or the structure and an unlocking position in which they do not lock the upper part, and
lower locking means that are mounted on the lower part and that are able to move between a locking position in which they lock the lower part with the structure and an unlocking position in which they do not lock the lower part.

With such an arrangement, the operator can remove the two halves easily without risk of collision with the surroundings.

Advantageously, the lower locking means have, for each side of the lower part, at least one bolt mounted so as to be able to move on the lower part and a strike as one with the structure, wherein each bolt is able to move between a locked position and an unlocked position, a handle mounted so as to be able to move on the lower part between a first position corresponding to the locked position of the bolts and a second position corresponding to the unlocked position of the bolts, and, for each bolt, a transmission system arranged to transmit the movement of the handle to said bolt.

Advantageously, the handle is mounted so as to be able to move in rotation about an opening axis, for each bolt, the lower part has guides arranged to guide said bolt in translation perpendicular to the opening axis, each transmission system takes the form of a rod of which one end is mounted so as to be able to move in rotation on the handle about an axis parallel to the opening axis and of which one end is mounted so as to be able to move in rotation on the bolt about an axis parallel to the opening axis, and the articulation of each rod to the handle is offset with respect to the opening axis.

Advantageously, the guiding system has a groove fastened to the structure or to the lower part, wherein the groove extends parallel to the direction of translation, and a rib fastened respectively to the lower part or to the structure and extending parallel to the direction of translation, wherein the rib is mounted so as to be able to slide inside the groove.

Advantageously, the access door assembly has at least one stop system disposed at a bottom part of the lower part, each stop system has a receptacle as one with the structure and of which the opening is oriented upwards, and a pin as one with the lower part, wherein the pin is received in the receptacle when the lower part is put back in place.

The invention also proposes an aircraft having a fuselage with a chassis and a door assembly according to one of the preceding variants, wherein the structure is as one with said chassis.

### BRIEF DESCRIPTION OF THE DRAWINGS

The abovementioned features of the invention, along with others, will become more clearly apparent upon reading the following description of one exemplary embodiment, said description being given with reference to the appended drawings, in which:

FIG. 1 is a schematic depiction viewed in cross section along a vertical plane of an aircraft of the prior art,

FIG. 2 is a view from above of an aircraft according to the invention,

FIG. 3 is a schematic depiction viewed in cross section along the line II-II in

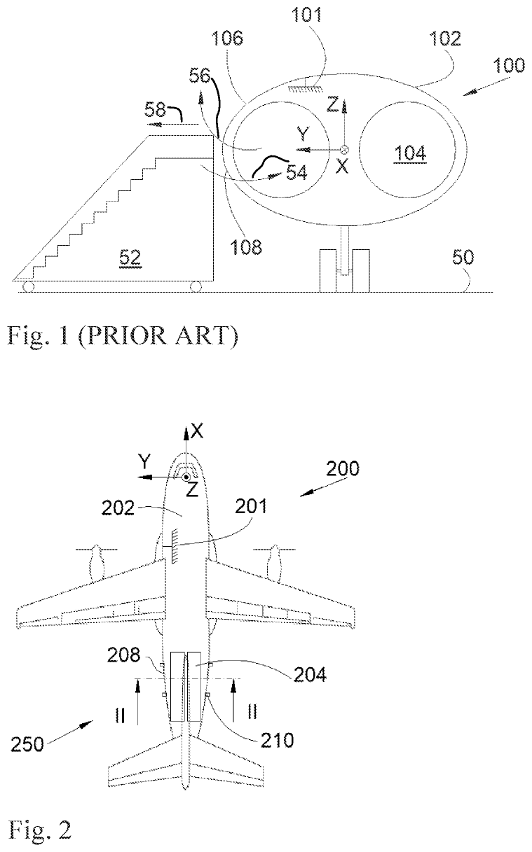

FIG. 2 of the aircraft according to the invention,

FIG. 4 is a perspective view of an access door for an assembly according to the invention,

FIG. 5 is a view from above and in cross section of lower locking means for an assembly according to the invention,

FIG. 6 is a perspective view of a guiding system for an assembly according to the invention, and

FIG. 7 is a perspective view of a bearing system for an assembly according to the invention.

### DETAILED DESCRIPTION OF THE PREFERRED EMBODIMENTS

In the following description, and by convention, the X direction is the longitudinal direction of the aircraft, the Y direction is the transverse direction, which is horizontal when the aircraft is on the ground, and the Z direction is the vertical direction, which is vertical when the aircraft is on the ground, these three directions X, Y and Z being mutually orthogonal.

FIG. 2 shows an aircraft 200 according to the invention that has a fuselage 202 inside which are arranged, in this case at the rear, two tanks 204, for example dihydrogen tanks for supplying, for example, engines of the aircraft 200. Each tank 204 in this case takes the form of a cylinder of which the axis is parallel to the longitudinal direction X.

The fuselage 202 has a chassis 201 on the outside of which are fastened panels forming an aerodynamic surface of the fuselage 202.

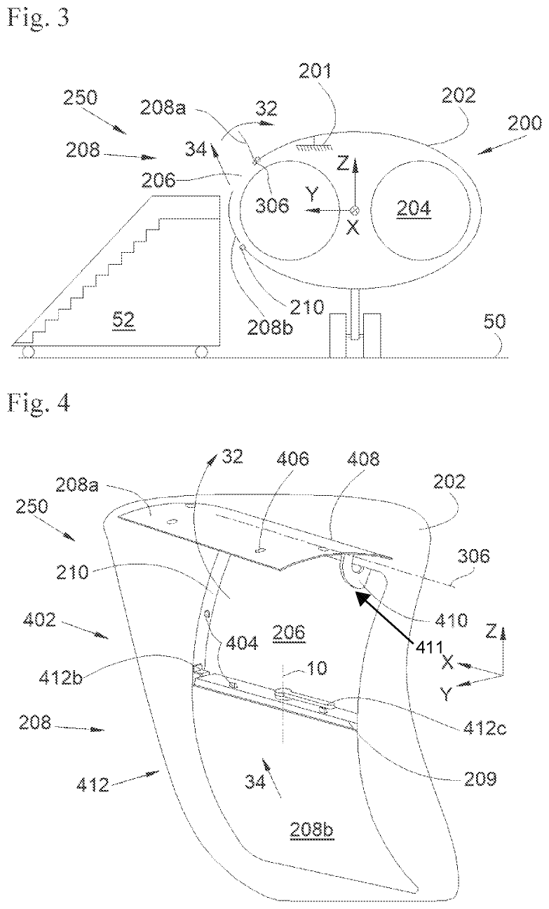

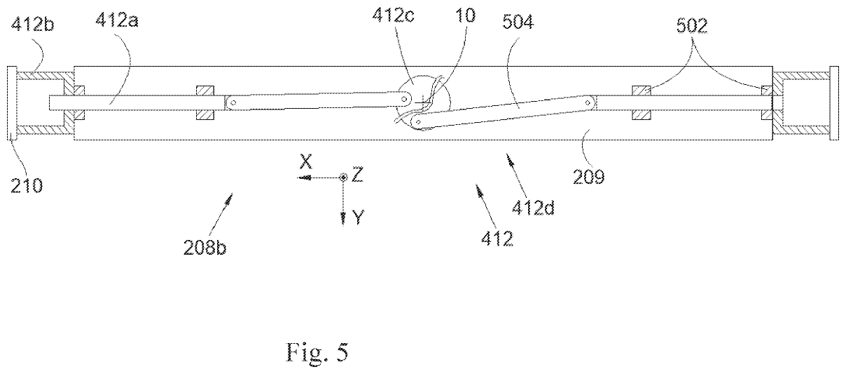

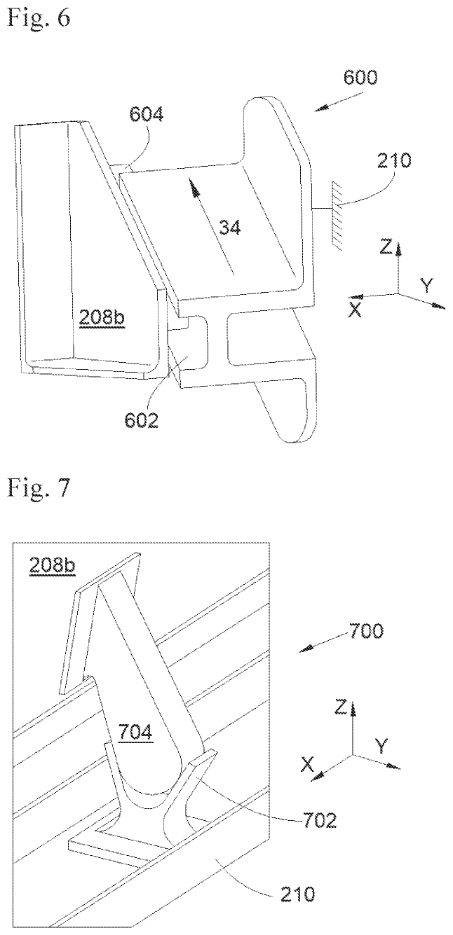

The fuselage 202 has, for each tank 204, an access door assembly 250 according to the invention and that has a structure 210 delimiting an access hatch (206, FIG. 3) and an access door 208 that is able to move between an open position in which it does not close off the access hatch 206 and a closed position in which it closes off the access hatch 206.

The structure 210 has a frame and is as one with the chassis 201 or constitutes a part thereof.

The outer surface of the access door 208 constitutes one of the panels of the fuselage 202 and is therefore in this case on the side of the fuselage 202, along the tank 204.

FIG. 3 shows the opening operation of the access door 208 that closes off the access hatch 206.

The access door 208 has an upper part 208a and a lower part 208b disposed below the upper part 208a. In this case, each part 208a-b extends generally over half the total height of the access door 208.

FIG. 4 shows the access door 208 with the upper part 208a open and the lower part 208b closed.

The upper part 208a is mounted articulated on the structure 210 via hinges 411 of the assembly 250. The hinges 411 are fastened between the structure 210 and the upper part 208a in the vicinity of an upper edge 408 of the upper part 208a and have a horizontal hinge axis 306. The upper part 208a thus opens outwards and upwards by rotation (arrow 32) about the hinge axis 306. Due to the small extent of the upper part 208a, there is no risk of collision with the boarding staircase 52 or the tank 204.

The assembly 250 also has guiding system (600, FIG. 6) that is arranged between the lower part 208b and the structure 210 and guides the lower the part 208b in translation with respect to the structure 210, parallel to a direction of translation (arrow 34) that is oriented towards the top and the outside of the fuselage 202 during the opening of the access door 208. The lower part 208b is then removed by sliding towards the top and the outside of the fuselage 202 and there is no risk of collision with the boarding staircase 52 or the tank 204.

The access door 208 is put back in place in the opposite way, i.e., by putting the lower part 208b back in place parallel to the direction of translation 34 but in the opposite direction, and by tilting the upper part 208a about the hinge axis 306 but in the opposite direction.

The assembly 250 has locking means 402, 412 of which embodiments are described below and which are accessible from the outside of the fuselage 202.

There are upper locking means 402 that are mounted on the upper part 208a and that are able to move between a locking position in which they lock the upper part 208a with the lower part 208b and/or the structure 210 and an unlocking position in which they do not lock the upper part 208a, which is then free to pivot.

There are lower locking means 412 that are mounted on the lower part 208b and that are able to move between a locking position in which they lock the lower part 208b with the structure 210 and an unlocking position in which they do not lock the lower part 208b, which is then free to move.

With such an arrangement, the access door 208 can easily be removed and put back in place without risk of collision with the surroundings.

Removing the access door 208 thus consists in moving the upper locking means 402 into the unlocking position, in pivoting the upper part 208a upwards, in moving the lower locking means 412 into the unlocking position and in pulling the lower part 208b upwards. Putting the access door 208 back in place thus consists in pushing the lower part 208b downwards, in moving the lower locking means 412 into the locking position, in pivoting the upper part 208a downwards and in moving the upper locking means 402 into the locking position.

In this case there are four upper locking means 402, with two that lock on the lower part 208b and two that lock on the structure 210. Each upper locking means 402 takes for example the form of a lock with a bolt mounted so as to be able to move on the upper part 208a and a strike 404 as one with the lower part 208b or the structure 210. Each bolt is movable from the outside of the upper part 208a between a locked position and an unlocked position via an appropriate handle 406.

The rotation of the upper part 208a about the hinge axis 306 is brought about in this case via gooseneck fittings 410 distributed along the upper edge 408 of the upper part 208a and forming the hinges 411.

FIG. 4 also shows a part of the lower locking means 412.

FIG. 5 shows a view from above and in cross section along a horizontal plane of the lower locking means 412 at a strip 209 disposed in the top part of the lower part 208b.

The lower locking means 412 have, for each side of the lower part 208b, i.e., in this case at the front and at the rear with respect to the longitudinal direction X, at least one bolt 412a mounted so as to be able to move on the lower part 208b and a strike 412b as one with the structure 210. Each bolt 412a is able to move between a locked position (FIG. 5 on the left) and an unlocked position (FIG. 5 on the right). The two bolts 412a simultaneously assume the same locked or unlocked position, but for the sake of explanation, FIG. 5 has been divided in two with one bolt 412a in the locked position on the left and one bolt 412a in the unlocked position on the right. In the embodiment of the invention that is presented here, there are two bolts 412a at the strip 209, but there could be a plurality of them over the height of the lower part 208b.

In the locked position, the bolt 412a is housed in the strike 412b so as to block the lower part 208b, and in the unlocked position, the bolt 412a is not housed in the strike 412b so as to release the lower part 208b.

The lower locking means 412 also have a handle 412c that is mounted so as to be able to move on the strip 209 of the lower part 208b between a first position corresponding to the locked position of the bolts 412a and a second position corresponding to the unlocked position of the bolts 412a.

The lower locking means 412 also have, for each bolt 412a, a transmission system 412d arranged to transmit the movement of the handle 412c to said bolt 412a.

In the embodiment of the invention that is presented in FIG. 5, the passage from the first position to the second position is effected by rotation of the handle 412c about an opening axis 10 that is in this case vertical.

Each bolt 412a moves perpendicular to the axis of opening 10, i.e. in this case horizontally and generally parallel to the longitudinal direction X. To this end, each bolt 412a is guided in translation by guides 502 as one with the strip 209 of the lower part 208b and each transmission system 412d takes the form of a rod 504 of which one end is mounted so as to be able to move in rotation on the handle 412c and of which one end is mounted so as to be able to move in rotation on the bolt 412a. The two rotations are effected about axes parallel to the opening axis 10. The articulation of each rod 504 to the handle 412c is offset with respect to the opening axis 10 in order to form a lever arm that pulls or pushes the rod 504 depending on the direction of rotation of the handle 412c.

FIG. 6 shows an embodiment of a guiding system 600 guiding the lower part 208b parallel to a direction of translation 34. There is a guiding system 600 on each side of the lower part 208b, i.e. in this case at the front and at the rear with respect to the longitudinal direction X.

The guiding system 600 has a groove 602 fastened to the structure 210, wherein the groove 602 extends parallel to the direction of translation 34, and a rib 604 fastened on the side of the lower part 208b and also extending parallel to the direction of translation 34, wherein the rib 604 is mounted so as to be able to slide inside the groove 602.

It is also possible to reverse the position of the groove 602 and the rib 604, i.e., the guiding system 600 has a groove 602 fastened to the structure 210 or to the lower part 208b, wherein the groove 602 extends parallel to the direction of translation 34, and a rib 604 fastened respectively to the lower part 208b or to the structure 210 and extending parallel to the direction of translation 34, wherein the rib 604 is mounted so as to be able to slide inside the groove 602.

In order to stop the translation of the lower part 208b during the putting back in place thereof, the access door assembly 250 has at least one stop system 700 depicted in FIG. 7 and disposed at the bottom part of the lower part 208b.

The stop system 700 has a receptacle 702 as one with the structure 210 and a pin 704 as one with the lower part 208b. The opening of the receptacle 702 is oriented upwards so as to receive the pin 704 when the lower part 208b is put back in place so as to close off the access hatch 206.

In order to seal the fuselage 202, seals are disposed between the structure 210 and the upper part 208a and the lower part 208b and also between the upper part 208a and the lower part 208b.

Although the access door assembly 250 has been described more particularly in the case of the presence of a dihydrogen tank 204, it can be put in place in other locations of the fuselage 202.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An access door assembly for a fuselage of an aircraft having a chassis, said assembly comprising:
a structure delimiting an access hatch and configured to be as one with said chassis,
an access door having an upper part and a lower part,
hinges fastened between the structure and the upper part in a vicinity of an upper edge of the upper part and having a horizontal hinge axis,
a guiding system arranged between the lower part and the structure and configured for guiding the lower part in translation with respect to the structure, parallel to a direction of translation configured to be oriented towards a top and an outside of the fuselage during opening of the access door,
upper locking means mounted on the upper part and configured to move between a locking position in which the upper locking means lock the upper part with the lower part, or the structure, or both, and an unlocking position in which the upper locking means do not lock the upper part, and
lower locking means mounted on the lower part and configured to move between a locking position in which the lower locking means lock the lower part with the structure and an unlocking position in which the lower locking means do not lock the lower part.

2. The access door assembly according to claim 1, wherein the lower locking means comprises,
for each side of the lower part, at least one bolt mounted so as to move on the lower part and a strike as one with the structure, wherein each bolt is configured to move between a locked position and an unlocked position,
a handle mounted so as to move on the lower part between a first position corresponding to the locked position of the at least one bolt and a second position corresponding to the unlocked position of the at least one bolt, and,
for each bolt, a transmission system configured to transmit the movement of the handle to said bolt.

3. The access door assembly according to claim 2, wherein the handle is mounted so as to move in rotation about an opening axis,
wherein, for each bolt, the lower part comprises guides arranged to guide said bolt in translation perpendicular to an opening axis,
wherein each transmission system comprises a rod having a first end mounted so as to move in rotation on the handle about an axis parallel to the opening axis and a second mounted so as to move in rotation on the bolt about an axis parallel to the opening axis, and
wherein an articulation of each rod to the handle is offset with respect to the opening axis.

4. The access door assembly according to claim 1, wherein the guiding system comprises
a groove fastened to the structure or to the lower part, wherein the groove extends parallel to the direction of translation, and
a rib fastened respectively to the lower part or to the structure and extending parallel to the direction of translation, wherein the rib is mounted so as to slide inside the groove.

5. The access door assembly according to claim 1, further comprising:
at least one stop system disposed at a bottom part of the lower part, wherein each stop system comprises
a receptacle as one with the structure and of which the opening is oriented upwards, and
a pin as one with the lower part, wherein the pin is configured to be received in the receptacle when the lower part is put back in place.

6. An aircraft comprising:
a fuselage with a chassis and
the access door assembly according to claim 1, wherein the structure is as one with said chassis.
